(19) United States
(12) Patent Application Publication
(10) Pub. No.: US 2013/0103969 A1
(43) Pub. Date: Apr. 25, 2013

(54) CLOCK GENERATION DEVICE FOR USB DEVICE

(71) Applicants: Jyh-Hwang Wang, Hsinchu City (TW); Wang-Tiao Huang, Hsinchu City (TW)

(72) Inventors: Jyh-Hwang Wang, Hsinchu City (TW); Wang-Tiao Huang, Hsinchu City (TW)

(21) Appl. No.: 13/278,600

(22) Filed: Oct. 21, 2011

(51) Int. Cl. G06F 1/04

(52) U.S. Cl. 713/502

(57) ABSTRACT

A clock generation device comprises a clock generation unit, a counter, a common factor calculation element, a first frequency divider, a phase-locked loop (PLL) and a second frequency divider. The counter receives a clock signal from the clock generation unit and a periodic signal from a USB host, and outputs a count value. The common factor calculation element calculates the common factor of the count value and a value to output a first adjustment value and a second adjustment value. The first frequency divider divides the frequency of the clock signal by the first adjustment value to output a reference signal. The second frequency divider divides the frequency of the output clock signal of the PLL by the second adjustment value to obtain a feedback signal input to the PLL. Based on the reference signal and the feedback signal, the PLL outputs a clock signal complying with the USB specification.

### BACKGROUND OF THE INVENTION

1. Field of the Invention

The present invention relates to a clock generation device, and more particularly to a clock generation device for a USB device.

2. Description of the Prior Art

The Universal Serial Bus (USB) interface has been ubiquitously used as a connecting interface for computer peripherals. According to the USB specifications, each USB system is composed of three elements, a USB host, USB inter-connection and a USB device(s). Types of USB devices include a USB function device such as a keyboard, mouse, and printer, etc., and a USB hub.

Besides, the USB specifications also specify ranges of signal frequency within which a receiving end may correctly capture transmitted data from a transmitting end. One of the ranges of signal frequency, provided here for illustration purpose, is 12 MHz±0.25%. Conventionally, in order to comply with the USB specification, it is widely adopted to use an accurate external clock source, such as a crystal oscillator, and then apply frequency multiplication to achieve functions of transmission and receiving a USB signal. Consequently, the USB controller costs more, and is less suitable to the USB device application. The oscillator circuit built-in to the USB controller, on the other hand, is susceptible to variations in manufacturing process, temperature and voltage conditions and so forth and the accuracy of which is more easily affected.

In brief, it is highly desirable to be capable of adjusting the frequency of an internal clock to comply with the USB specification.

### SUMMARY OF THE INVENTION

The present invention is directed to a clock generation device for a USB device. The clock generation device includes a phase-locked loop and uses a first adjustment value and a second adjustment value output from a common factor calculation element to reduce the difference between a reference signal and a feedback signal input to the phase-locked loop, and decrease signal jitter of the reference signal, thereby lowering the signal jitter of the output clock signal from the phase-locked loop to match the internal clock with the USB specification.

According to an embodiment, a clock generation device for a USB device includes a clock generation unit, a counter, a common factor calculation element, a first frequency divider, a phase-locked loop and a second frequency divider. The clock generation unit is for generating a clock signal. The counter is connected electrically with the clock generation unit and is for receiving the clock signal and a periodic signal generated by a USB host to output a count value corresponding to the clock signal. The common factor calculation element is connected electrically with the counter and is for calculating a common factor of the count value and a value generated by a value generator to output a first adjustment value and a second adjustment value. The first frequency divider is connected electrically with the clock generation unit and the common factor calculation element, and is for dividing the frequency of the clock signal by the first adjustment value to output a reference signal. The phase-locked loop is connected electrically with the first frequency divider and is for receiving the reference signal and a feedback signal to output a first output clock signal. The second frequency divider is connected electrically with the phase-locked loop and the common factor calculation element and is for dividing the frequency of the first output clock signal by the second adjustment value to obtain the feedback signal to be input to the phase-locked loop.

The objective, technologies, features and advantages of the present invention will become more apparent from the following description in conjunction with the accompanying drawings, wherein certain embodiments of the present invention are set forth by way of illustration and examples.

### BRIEF DESCRIPTION OF THE DRAWINGS

FIG. 1 is a block diagram schematically illustrating a clock generation device for a USB device according to an embodiment of the present invention.

### DESCRIPTION OF THE PREFERRED EMBODIMENT

The clock generation device of the present invention is primarily for a USB device in a USB system to have a synchronizing frequency with a USB host during transmission of data through a USB interface so as to achieve synchronizing the transmitted data without a mistake. During USB transmission, the USB device may receive the clock period information from the transmitted data such as from a SYNC signal at the beginning of a data packet or a Start of Frame (SOF) signal, which for instance, is generated every 1 ms according to the USB specification. The clock generation device of the present invention uses the periodic signal transmitted by the USB host to lock an internal clock of the USB device.

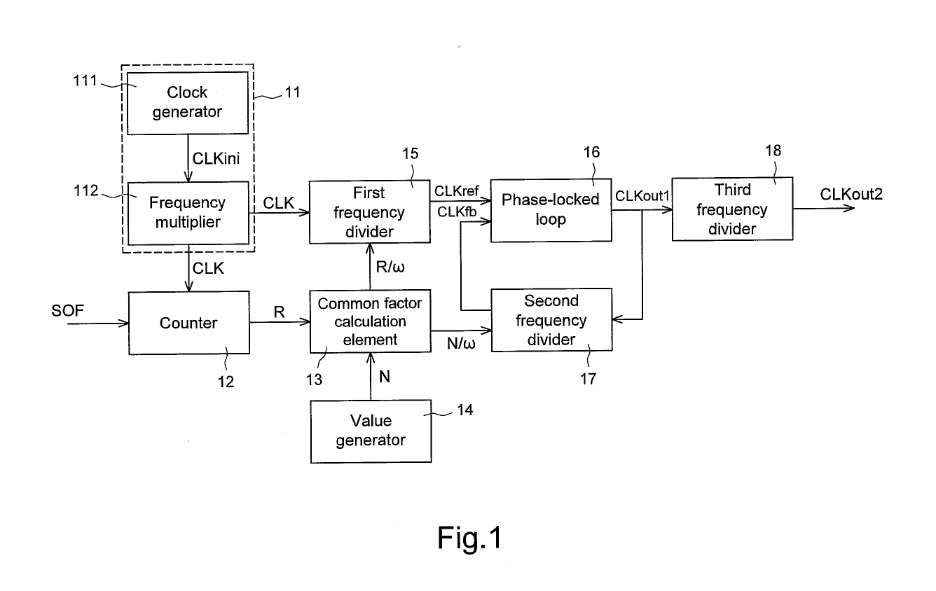

The following is an example illustrating the configuration of the clock generation device using the SOF signal according to the present invention. Referring to FIG. 1, the clock generation device according to an embodiment includes a clock generation unit 11, a counter 12, a common factor calculation element 13, a first frequency divider 15, a phase-locked loop (PLL) 16 and a second frequency divider 17. The clock generation unit 11 is for generating a clock signal CLK. According to an embodiment, the clock generation unit 11 may include a clock generator 111 and a frequency multiplier 112. The clock generator 111 is for generating an initial clock signal CLKini. The frequency multiplier 112 is electrically connected with the clock generator 111 and is for multiplying the frequency of the initial clock signal CLKini to obtain the clock signal CLK of a higher frequency. For instance, the clock generator may be an RC oscillator which is capable of generating a continuous oscillating signal, is lower cost, has a more simple design and is suitable for being used an internal clock generator. Other types of prior art clock generators may also be adapted to be used in the present invention.

The counter 12 and the clock generation unit 11 are electrically connected so as to receive the clock signal CLK generated by the clock generation unit 11. The counter 12 also receives an SOF signal generated by the USB host. The period between rising edges or falling edges of two consecutive SOFs in the SOF signal is used as a unit time. The counter 12 may count pulses of the clock signal CLK to obtain a corresponding count value R. According to an embodiment, the count value R is a counting number. It is noted that the frequency of the clock signal CLK may be larger than that of the periodic signal to facilitate recognizing of the periodic signal.

The common factor calculation element 13 is electrically connected with the counter 12 to obtain the count value R output from the counter 12. In addition, the common factor calculation element 13 is also electrically connected with a value generator 14 to receive a value N generated by the value generator 14. According to an embodiment, the value N is a counting number. The common factor calculation element 13 then calculates the common factor ω of the count value R and the value N and outputs a first adjustment value and a second adjustment value, wherein the first adjustment value is a ratio of the count value R and the common factor w; the second adjustment value is a ratio of the value N and the common factor ω. According to an embodiment, the common factor ω is the largest common factor of the count value R and the value N.

The first frequency divider 15 is electrically connected with the clock generation unit 11 and the common factor calculation element 13. The first frequency divider 15 divides the frequency of the clock signal CLK by the first adjustment value (R/ω) output from the common factor calculation element 13 to output a reference signal CLKref. The phase-locked loop 16 is electrically connected with the first frequency divider 15 to receive the reference signal CLKref output from the first frequency divider 15. The phase-locked loop 16 also receives a feedback signal CLKfb to output a first output clock signal CLKout1. A second frequency divider 17 is electrically connected with the phase-locked loop 16 and the common factor calculation element 13. The second frequency divider 17 divides the first output clock signal CLKout1 by the second adjustment value (N/ω) produced by the common factor calculation element 13 to obtain the feedback signal CLKfb and input the feedback signal CLKfb to the phase-locked loop 16.

According to an embodiment, the clock generation device further includes a third frequency divider 18 electrically connected with the phase-locked loop 16. The third frequency divider 18 divides the first output clock signal CLKout1 output from the phase-locked loop 16 by a constant factor to output a second output clock signal CLKout2 which is used as the operational clock for data transmission.

According to the aforementioned configuration, as long as the frequency of the initial clock signal CLKini generated by the clock generator 111 is within the range of 12 MHz±5%, the configuration of the present invention would be able to output a clock signal with a frequency complying with the USB specification, i.e. within the range of 12 MHz±0.25%.

For instance, the initial clock signal CLKini generated by the clock generator 111 has a frequency of 12 MHz+5%, i.e. 12.6 MHz. The frequency of the initial clock signal CLKini is quadrupled to result in the clock signal CLK, of which the frequency is 48 MHz+5%, i.e. 50.4 MHz. The unit time between two SOFs is 1 ms. Therefore, the counter 12 would count 50400 pulses in the clock signal CLK per 1 ms, i.e. the count value R is equal to 50400. The value N output from the value generator 14 is 48000. The common factor calculation element 13 may then obtain the largest common factor of the count value R and value N to be 2400. Therefore, the first adjustment value (R/ω) is equal to 21 (50500/2400); the second adjustment value (N/ω) is equal to 20 (48000/2400). According to the aforementioned data, the frequency of the reference signal CLKref output from the first frequency divider 15 is 2400 KHz (50.4 MHz/21). Since the frequency of the first output clock signal CLKout1 output from the phase-locked loop is set to be 48 MHz, the frequency of the feedback signal CLKfb output by the second frequency divider 17 is 2400 KHz (48 MHz/20). The first output clock signal CLKout1 output from the phase-locked loop 16 after a frequency division process by the third frequency divider 18 would become the clock signal complying with the USB specification.

As mentioned above, the first adjustment value (R/ω) and the second adjustment value (N/ω) output from the common factor calculation element 13 are to make the reference signal CLKref and the feedback signal CLKfb output respectively from the first frequency divider 15 and the second frequency divider 17 to be closer. Additionally, the configuration of the present invention may reduce signal jitter of the reference signal CLKref, thereby lowering the signal jitter of the output clock signal from the phase-locked loop 16. Therefore, the initial clock signal CLKini generated by the built-in clock generator 111 may also be used to generate the clock signal complying with the USB specification.

To summarize the foregoing description, the clock generation device for the USB device uses the first adjustment value and the second adjustment value output by the common factor calculation element to reduce the difference between the reference signal and the feedback signal input to the phase-locked loop, and decrease signal jitter of the output clock signal output from the phase-locked loop. Hence, by using the phase-locked loop, the clock generation device of the present invention is able to use a clock signal of larger frequency error to generate a clock signal complying with the USB specification, thereby lowering the cost of using an external clock.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

What is claimed is:

1. A clock generation device for USB device comprising:
a clock generation unit for generating a clock signal;
a counter connected electrically with the clock generation unit and being for receiving the clock signal and a periodic signal generated by a USB host to output a count value corresponding to the clock signal;
a common factor calculation element connected electrically with the counter and being for calculating a common factor of the count value and a value generated by a value generator to output a first adjustment value and a second adjustment value;
a first frequency divider connected electrically with the clock generation unit and the common factor calculation element, and being for dividing the frequency of the clock signal by the first adjustment value to output a reference signal;
a phase-locked loop connected electrically with the first frequency divider and being for receiving the reference signal and a feedback signal to output a first output clock signal; and
a second frequency divider connected electrically with the phase-locked loop and the common factor calculation element and being for dividing the frequency of the first output clock signal by the second adjustment value to obtain the feedback signal to be input to the phase-locked loop.

2. The clock generation device for USB device according to claim 1, further comprising:
a third frequency divider connected electrically with the phase-locked loop and being for dividing the frequency of the first output clock signal by a constant factor to output a second output clock signal.

3. The clock generation device for USB device according to claim 1, wherein the common factor is the largest common factor of the count value and the value.

4. The clock generation device for USB device according to claim 1, wherein the first adjustment value is equal to the count value divided by the common factor.

5. The clock generation device for USB device according to claim 1, wherein the second adjustment value is equal to the value divided by the common factor.

6. The clock generation device for USB device according to claim 1, wherein the count value is a counting number.

7. The clock generation device for USB device according to claim 1, wherein the value is a counting number.

8. The clock generation device for USB device according to claim 1, wherein the frequency of the clock signal is larger than that of the periodic signal.

9. The clock generation device for USB device according to claim 1, wherein the clock generation unit comprises a clock generator for generating an initial clock signal; and a frequency multiplier connected electrically with the clock generator and being for multiplying the frequency of the initial clock signal to obtain the clock signal of the higher frequency.

10. The clock generation device for USB device according to claim 9, wherein the frequency of the initial clock signal generated by the clock generator is 12 MHz±5%.

11. The clock generation device for USB device according to claim 1, wherein the frequency of the clock signal generated by the clock generation unit is 48 MHz±5%.
